(19) United States
(12) Patent Application Publication
(10) Pub. No.: US 2015/0369276 A1
(43) Pub. Date: Dec. 24, 2015

(54) High Stiffness Suction Cup Device

(71) Applicant: DayMen US, Inc., Petaluma, CA (US)

(72) Inventors: Noah Balmer, Oakland, CA (US); Fred Italo Polito, Santa Cruz, CA (US)

(21) Appl. No.: 14/312,647

(22) Filed: Jun. 23, 2014

(51) Int. Cl. F16B 47/00; F16M 13/02

(52) U.S. Cl. CPC F16B 47/00; F16M 13/022

(57) ABSTRACT

A suction cup attachment device adapted to provide a high stiffness mounting support. The suction cup is restrained around its rim and pulled via a piston attached to its center. The piston is pulled through a cylinder and pressure is provided against a support surface close to the exterior of the cylinder.

### BACKGROUND

1. Field of the Invention

This invention relates to a suction cup, and more specifically to rigid suction cup device with high stiffness.

2. Description of Related Art

Suction cups are used to mount objects to smooth surfaces. The cup itself may be made of rubber, or a rubberized plastic. The cup may have its external rim area pressed against the mounting surface while the cup center is pulled upwards. The external rim area may then form an airtight seal and a reduced pressure area within the cup results in a sealed mount upon the smooth surface.

A drawback with prior designs relates to a lack of stiffness of the mounting unit, such that the supported device may have some wobble, or be subject to shaking, for example. Another drawback to prior designs is that the method of creating the seal, such as by rotation of an element of the device, does not involve an interface to the user which is able to be fully grasped from any direction.

What is called for is a suction cup design which incorporates aspects adapted to provide significant stiffness to the mounted system. What is also called for is a suction cup design which allows for full and easy gripping of the portion of the device which sets the suction of the device.

### SUMMARY

A suction cup attachment device adapted to provide a high stiffness mounting support. The suction cup is restrained around its rim and pulled via a piston attached to its center. The piston is pulled through a cylinder and pressure is provided against a support surface close to the exterior of the cylinder.

### BRIEF DESCRIPTION OF THE DRAWINGS

FIGS. 1A-E are views of a suction cup device according to some embodiments of the present invention.

FIG. 2 is an exploded view of a suction cup device according to some embodiments of the present invention.

FIG. 3 is an exploded view of a suction cup device according to some embodiments of the present invention.

FIG. 4 is a cross-sectional view of a suction cup device according to some embodiments of the present invention.

FIG. 5 is a cross-sectional view of a suction cup device according to some embodiments of the present invention.

FIGS. 6A-D are views of a cup housing according to some embodiments of the present invention.

FIGS. 7A-B are views of an inner engagement ring according to some embodiments of the present invention.

FIG. 8 is a perspective view of an outer engagement ring according to some embodiments of the present invention.

FIG. 9 is a perspective view of an engagement grip ring according to some embodiments of the present invention.

FIG. 10 is a perspective view of a cup piston according to some embodiments of the present invention.

FIGS. 11A-B are views of a suction cup according to some embodiments of the present invention.

FIGS. 12A-B are views of a device top piece according to some embodiments of the present invention.

### DETAILED DESCRIPTION

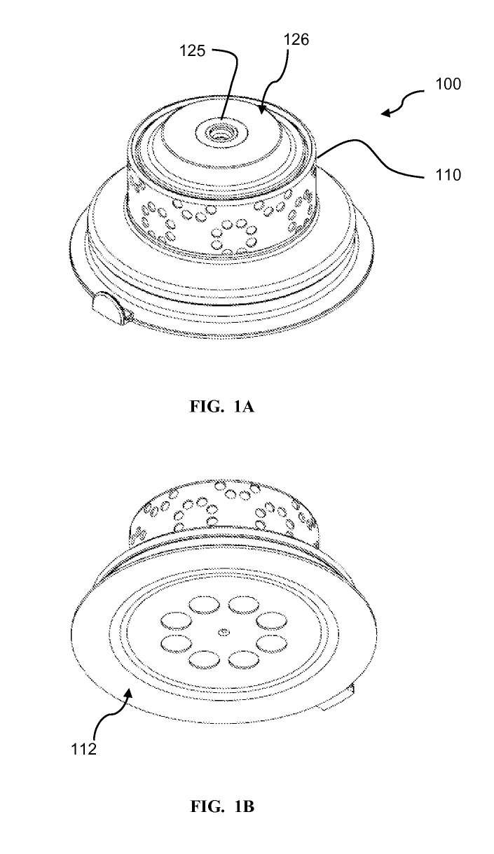

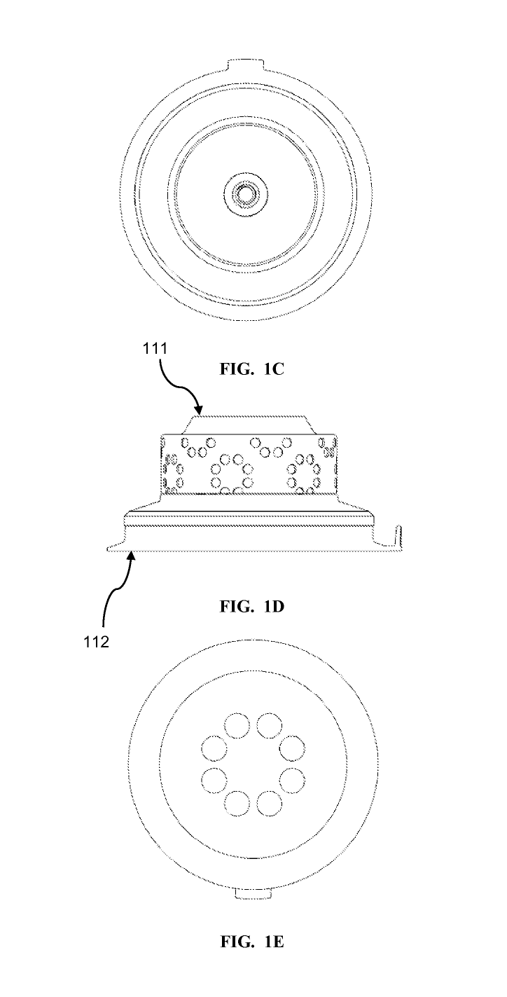

FIGS. 1A through 1E illustrate views of a suction cup device 100 according to embodiments of the present invention. The suction cup device 100 is adapted to support an item, which may be residing on the top mounting surface 126, and may also be fastened to the threaded insert 125. The suction cup device 100 is adapted to removably fasten to a smooth surface. The outer surface 112 of the suction cup provides a seal to the smooth surface as the center of the suction cup is withdrawn upward, as described below. The grip ring 110 provides an axially symmetric gripping surface for the user to grip, and to twist, to fastent he suction cup device to the surface. The grip ring 110 is not at the full radial distance of the outer portion of the suction cup, but is instead at a lesser radius, gripping surface which is perpendicular to the mounting surface, again allowing for better gripping by the user. Also, the axially symmetric grip ring 110 allows the user to approach the suction cup device 100 from any angular position along the exterior of the grip ring 110.

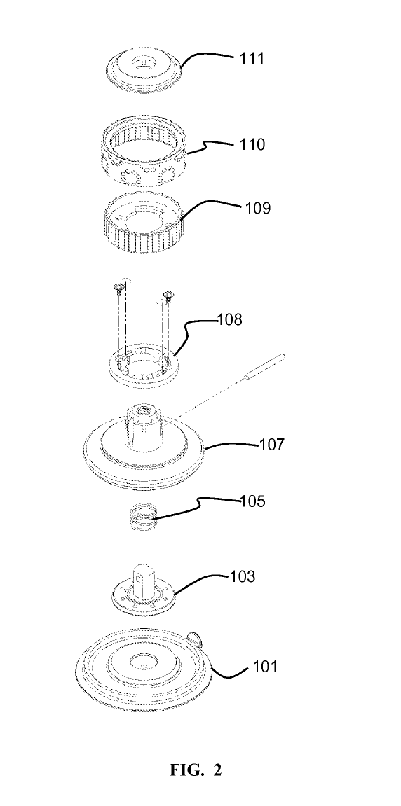

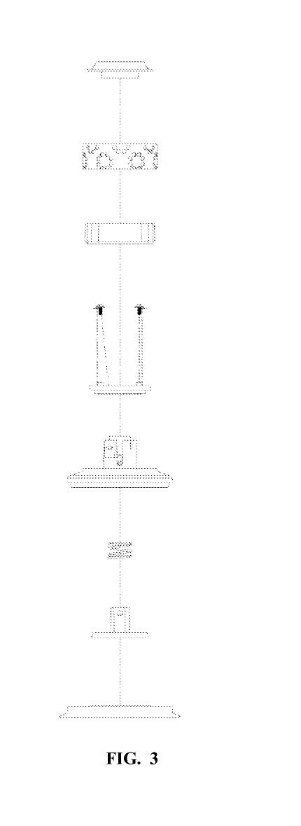

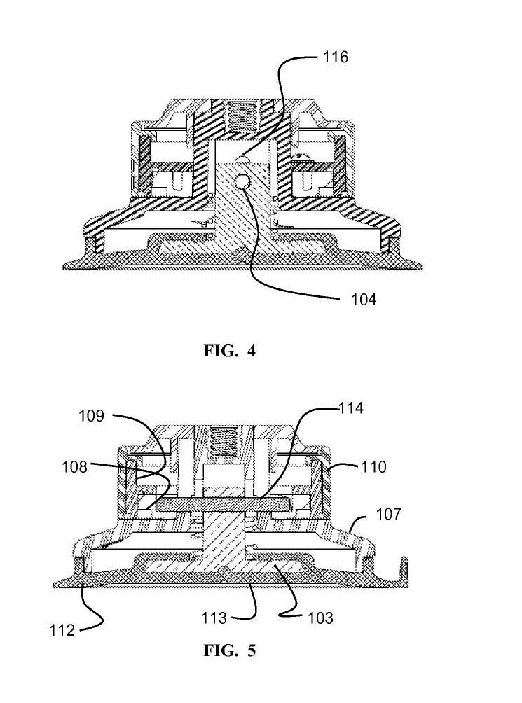

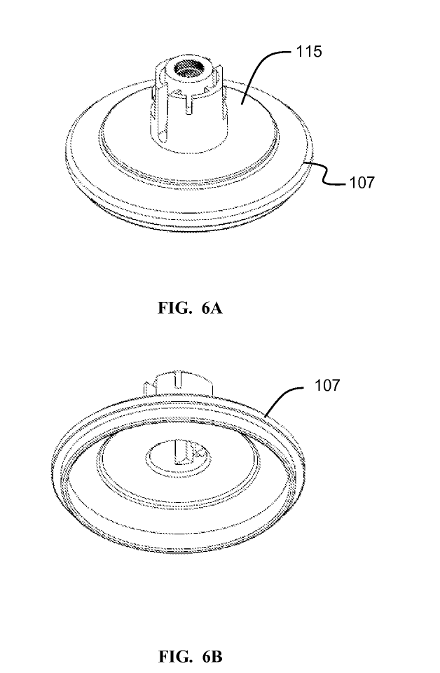

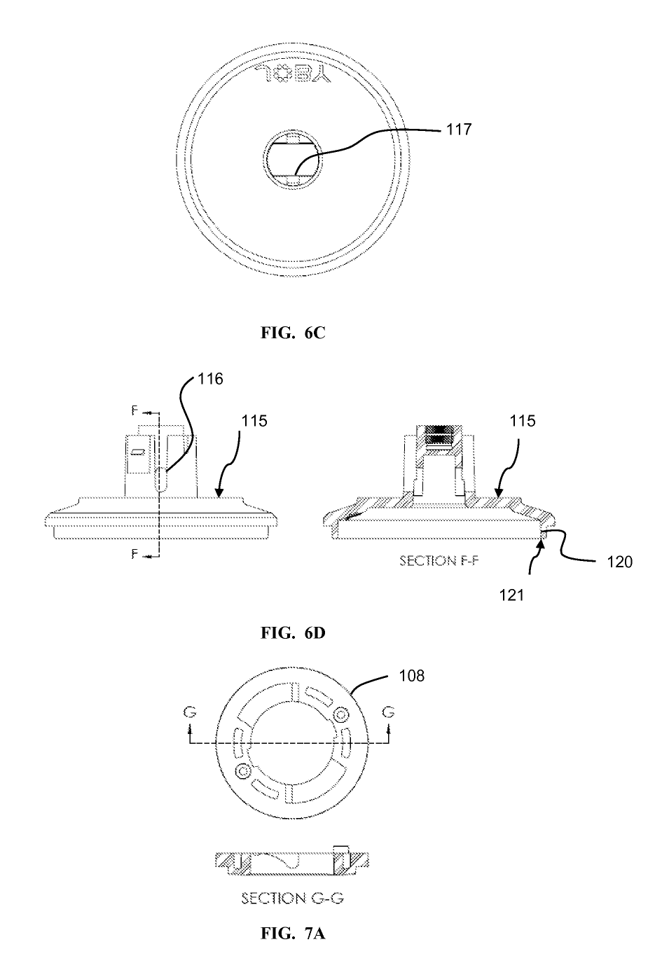

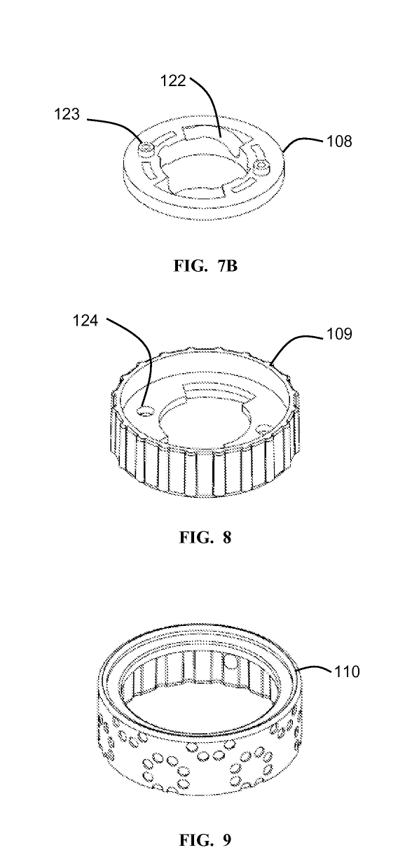

FIGS. 4 and 5 are orthogonal cross-sectional views of the suction cup device 100 as seen in FIGS. 1A-E. FIGS. 2 and 3 are orthogonal exploded views of the suction cup device 100 according to some embodiments of the present invention. As seen in these figures, the suction cup device 100 is constructed such that the mounting to a surface is stiff. The device top piece 111 is rigidly mounted to the cup housing 107. The cup housing 107 and the top piece 111 are keyed to each other to prevent rotation, and to enhance the stiffness of their connection. The top and sides of the outside of the central cylinder of the cup housing 107 fit snugly within mating surface of the bottom side of the device top piece 111. As seen in FIGS. 6A-D and 11A-B, a bottom surface 121 of the cup housing 107 is adapted to contact an inner surface 119 of the suction cup 101. The suction cup portion exterior and under the inner surface 119 of the suction cup 101, along surface 112 of the exterior bottom of the suction cup 101, becomes the interface and contact point of the suction cup device 100 to the smooth mounting surface. The lower exterior ring 120 of the cup housing 107, along with the bottom surface 121, fit into the recess 119 along the back of the suction cup 101 such that good and firm gripping between the housing and the suction cup occurs as the suction cup is fastened to a surface.

The top surface 126 of the top piece 111, along with the threaded insert 125, provide the other interface and contact point of the suction cup device. These rigid the single piece cup housing 107, along with the snugly overlaid top piece 111, provide a rigid continuity of structural support not seen in other devices. This rigidity provides for better adherence of the suction cup to a mounting plane, as there is less opportunity for irregular pressure around the circumference of the cup housing. Also, this rigidity allows for better function, and wobble and other disturbance is greatly reduced with this rigid structure configuration.

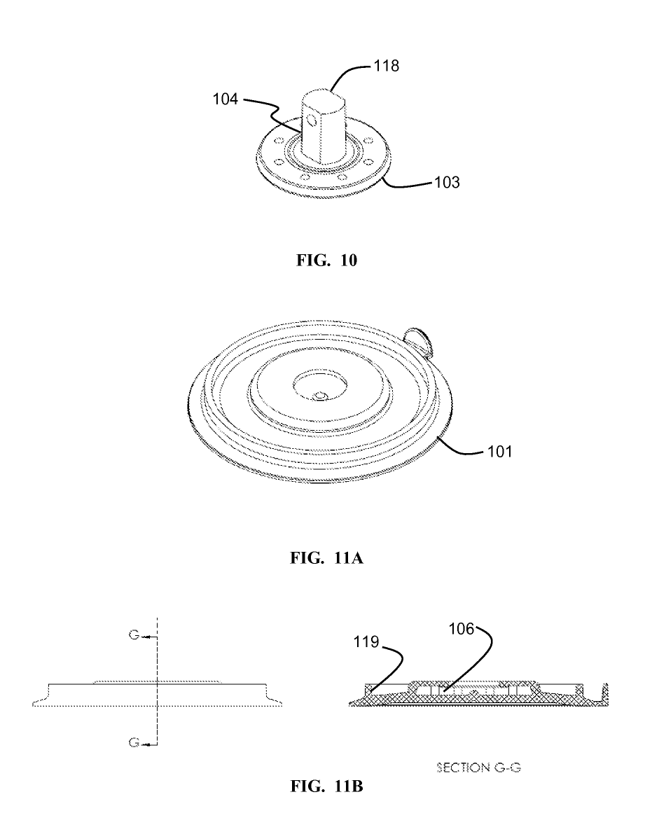

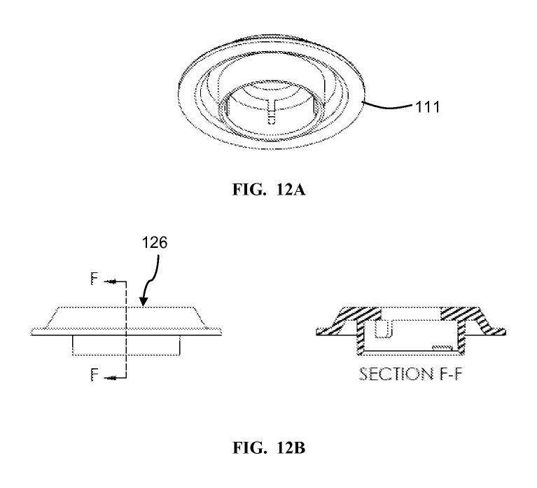

Another aspect of the rigid nature of the suction cup device 100 regards the sliding fit of the shaft 118 of the cup piston 103 into the mating cylinder 117 of the cup housing 107. The cup piston 103 is molded into the suction cup 101 and then inserted into the mating cylinder 117 of the cup housing 107. As seen in FIG. 10, the shaft 118 also has a pin hole 104 adapted to receive a pin 114. The pin 114 is pushed on from below to withdraw the central portion 113 of the suction cup 101. The pin is slid upwards in a vertical slot 116 within the cylinder of the cup housing 107. The vertical slot 116 provides clearance for the raising up of the pin 114, and the central portion 113 of the suction cup 101 to which it is coupled, while providing the least interference with the stiffness of the system. The combination of the vertical slot, and the central piston snugly sliding within a mating cylinder of the housing, allow for a stiffness of the mounting base not seen with any prior types of design.

The creation of the suction in the suction cup, which creates the attachment of the suction cup device 100 to the surface to which it is be affixed, is achieved by the rotation of the grip ring 110 by the user. The grip ring 110 engaged around the exterior of a set of pieces which will raise the pin 114. The grip ring 110 is affixed around the exterior of the outer engagement ring 109. The outer engagement ring 109 is attached to the inner engagement ring 108, and may be attached with fasteners. The inner engagement ring 108 has sloped surfaces 122 such that as the inner engagement ring 108 is rotated, the sloped surfaces 122 put axial pressure on the pin 114 such that the suction cup is activated. Once released, the cup may be further loosened by pulling on the release tab 102.

The grip ring 110, the outer engagement ring 109, and the inner engagement ring 109 are adapted to move as a unit. The inner engagement ring 108 may have guides 123 adapted to fit into guide holes 124 in the outer engagement ring 109. The upper surface 115 of the cup housing 107 provides a forcing surface for the bottom of the engagement ring assemble to push on, as it raises the ping 114. Thus the device top piece 111, the main cup housing 107, and the suction cup 101 all are rigidly linked to provide a very rigid suction cup attachment. The piston 103 is snugly within the cylinder of the housing 107, providing another level of stiffness. The slot 116 is vertical and thus reduces the bending stiffness of the cylinder by the least amount possible.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A suction cup device adapted to provide a stiff suction cup mounting, said suction cup device comprising:
a suction cup;
a main cup housing, said main cup housing comprising:
a first surface adapted to press on the back of said suction cup;
a hollow cylinder affixed to the center of said main cup housing; and
vertical slots in said hollow cylinder adapted to allow the sliding of a horizontal through pin;
a cup piston, said cup piston adapted to slide within said hollow cylinder on a first end, said cup piston affixed to said suction cup on a second end, said cup piston comprising a horizontal through hole;
a pin, said pin inserted through said horizontal through hole of said cup piston and extending past the exterior of said hollow cylinder on both ends; and
an engagement assembly, said engagement assembly adapted to raise said pin relative to said main cup housing, thereby engaging the suction cup device.

2. The suction cup device of claim 1 wherein said suction cup comprises a rubberized compound.

3. The suction cup device of claim 1 further comprising a top piece, said top piece capturing said engagement assembly between a lower surface of said top piece and an outer upper surface of said main cup housing.

4. The suction cup device of claim 3 wherein said suction cup comprises a rubberized compound.

5. The suction cup device of claim 4 wherein said top piece comprises a flat top mounting surface.

6. The suction cup device of claim 5 wherein said top piece further comprises a threaded insert.
